(19) United States
(12) Patent Application Publication
(10) Pub. No.: US 2002/0007267 A1
(43) Pub. Date: Jan. 17, 2002

(54) Expanded search and display of SAO knowledge base information

(76) Inventors: Leonid Batchilo, Belmont, MA (US); Igor Sovpel, Minsk (BY); Valery Tsourikov, Boston, MA (US)

Correspondence Address: STANGER & DREYFUS, 608 SHERWOOD PKWY, MOUNTAINSIDE, NJ, 07092, US

(21) Appl. No.: 09/785,018

(22) Filed: Feb. 16, 2001

Related U.S. Application Data
(60) Provisional application No. 60/198,918, filed on Apr. 21, 2000.

(51) Int. Cl. G06F 17/27; G06F 17/21; G06F 17/30

(52) U.S. Cl. 704/9; 704/1; 704/10; 707/4; 704/5

(57) ABSTRACT

In a digital computing system, the method of and apparatus for storing data representing a natural language sentence segment that includes at least one action (A) and one object (O) of the action, extracting the AO to form an AO extraction, processing the AO extraction pursuant to paraphrasing rules to form a plurality of para-AOs, and using the plurality of para-AOs during subsequent processing steps to be implemented in the digital computing system. One embodiment includes processing a natural language user request processing the AO extraction pursuant to positive and negative paraphrasing rules to form a plurality of para-AOs, and using the plurality of para-AOs as an expanded user request to search for information. An optional feature includes combining the S with each para-AO to form a plurality of para-SAOs as an expanded user request to search for information. The system can also include processing natural language documents, extracting a plurality of subject, action, object triplets (SAOs), normalizing the SAOs into SAO structures and storing the SAO structures in an SAO knowledge base. The system can employ the above mentioned paraphrasing rules for grouping a plurality of the SAOs that include various subjects (S₁, S₂, . . . Sₙ) each of which is associated with an AO (A₁O₁, A₂O₂, . . . A₃O₃) wherein A₁O₁, . . . A₂O₂, . . . A₃O₃ have a common meaning. Thus, a single user request SAO or AO can cause display of a plurality of grouped SAOs to increase the power of the search.

### RELATED APPLICATION

U.S. patent application Ser. No. 60/198,918, filed Apr. 21, 2000.

### BACKGROUND

The present invention relates to the field of computer based natural language processing.

Great advancements have been recently made in the field of computer based natural language processing. More recently, the method of generating and processing SAO (subject-action-object) extractions and structures as disclosed in U.S. patent application Ser. No. 09/541,182, filed Apr. 3, 2000 have produced substantially more reliable processing results with greater precision than previously known systems and methods. Although there can be many applications of SAO processing, recent commercial examples of an application of the SAO processing method can be seen at www.cobrain.com and the KNOWLEDGIST software offered by the Invention Machine Corporation, Boston, Massachusetts, USA.

It is common among known natural language processing systems to include a synonyms word dictionary so that one or more synonyms of a word being processed can be considered for substitution for the original processed word. See for example U.S. Pat. Nos. 5,742,834; 5,649,221; 5,469,355. Further U.S. Pat. No. 5,237,502 purports to provide a method of paraphrasing information contained in logical forms. It has been found that although these techniques contribute somewhat to processing reliability, these prior known techniques cannot discern or sense the meaning of a combination of words nor the equivalent meaning of the word combination. Nor do they have ability of processing and conveying SAO structures into an SAO Knowledge Base. This ability is important because it would (i) enhance the normalization of processed sentences (ii) increase the group of stored phrases that have one equivalent meaning, and (iii) expand the user request for specific document information thus enhancing the semantic capability of the overall processing system and subsequent management and display of information.

For example,

Direct synonym words substitutions allow the user to identify only direct SAO synonyms, like

S1-A1-O1=S2-A2-O2 because of S1=S2, A1=A2,O1=O2

For example,

S1 (refrigerator)-A₁ (perform)-O₁ (oil cooling)=S2 (fridge)-A2 (achieve)-O2 (oil chilling)

Because there is a dictionary:

S1 (refrigerator)=S2 (fridge)

A₁ (perform)=A2 (achieve)

O₁ (oil cooling)=O2 (oil chilling)

However, the synonym dictionaries are not able to identify the indirect SAO-synonyms, like

S1-A1-O1=S2-A2-O2, because of S1=S2 and A1-O1=A2-O2 in spite of A1=/=A2, O1=/=O2,

For example,

S1 (refrigerator)-A₁ (perform)-O₁ (oil cooling)=S2 (refrigerator)-A₂ (cool)-O₂ (oil)

Because

A₁ (perform)-O₁ (oil cooling)=A₂ (cool)-O₂ (oil)

In spite of

A₁ (perform)=/=A₂ (cool)

O₁ (oil cooling)=/=O₂ (oil)

### SUMMARY OF EXEMPLARY EMBODIMENT

It is an object of the present invention to provide a computer based system and method for syntactically processing word combinations each having a meaning or semantic content by modifying each word combination according to sets of paraphrasing word combination and modification rules stored in the system.

These rules are based on the AO (action object) portion of the SAO triplets and apply to positive (e.g. cool oil) and negative (e.g. do not cool oil) expressions. Converting or modifying all AO's in some stage or routine of the process normalizes the expression of the meaning of each AO without changing its meaning or, stated another way, the present system generates normalized expressions of the equivalent meaning of the respective AO for further use within the processing system.

### DRAWINGS

Other objects, advantages, and benefits will become apparent with the following detailed description of one exemplary embodiment of a system and method according to the principles of the present invention when taken in view of the appended drawings, in which:

FIG. 1 is a flow diagram of the main processing operations of an exemplary embodiment or method according to the principles of the present invention for expanding the user query search request.

FIG. 2 is a flow diagram of the main processing operations of an exemplary embodiment or method according to the principles of the present invention for grouping the para-AOs of an SAO Knowledge Base to form a compressed SAO Knowledge Base.

FIG. 3 shows a detail method step of stage 26 of FIG. 2.

### DETAILED DESCRIPTION

The following are incorporated herein by reference:

1. System and on-line information service presently available at www.cobrain.com and the publicly available user manual therefor.

2. The software product presently marketed by Invention Machine Corporation of Boston, USA (IMC), under it's trademark “KNOWLEDGIST” and the publicly available user manual therefor.

3. WIPO Publication 00/14651, Published Mar. 16, 2000.

4. U.S. patent application Ser. No. 09/541,182 filed Apr. 3, 2000.

5. IMC's COBRAIN® server software marketed in the United States and manuals thereof.

The present invention can be implemented as a computer based system and method such as disclosed in the above references 1-5. Thus, the software hereof can reside on a PC, server, or other general computer.

As stated above, it is one object of the present invention to generate normalized expression of equivalent meaning of a respective AO for use in subsequent processing.

It is another object to enhance or broaden the scope of a user request that forms the basis of searching for, acquiring and processing information. Such a user request could be in the form of a phrase, sentence (statement or question), paragraph, or entire document entered by the user such as with the keyboard, scanner, voice recognition device, etc. By broadening the scope of user request, the present system will search for a broader range of candidate documents for processing into candidate or stored SAO structures in the SAO Knowledge Base. The present system achieves such broadening by processing the user natural language request to identify the request SAO structures. It then processes these structures by applying a number of AO paraphrasing or normalizing rules to generate a larger number of AO structures that have a significantly equivalent meaning to each original processed SAO structure. As described below, one exemplary embodiment of the present invention has produced about 200 paraphrased AOs (hereafter para-AO) for every user request AO processed. Since the 200 para-AOs mean essentially the same as the user request AO but express such meaning differently, using the 200 para-AOs for the search request enhances the reliability of the ultimate search results.

Also, as stated above it is an object of the present invention to manage the SAO Knowledge Base information in such a way that enables display of not only the Knowledge Base SAO that exactly matches the request SAO but also displays for the user automatically or at user's selection the para-AOs that are equivalent in meaning to the displayed or selected Knowledge Base AO. In this way, user has a greater choice of specifically expressed Knowledge Base AOs to consider and can select the specifically expressed para-AOs nearest his/her interest and/or base user's selection on words displayed near respective AO and para-AO.

### DEVELOPMENT OF PARA-AOs

### EXAMPLE NO. 1

### User Enters a Word String With at Least One SAO) and Elements

One exemplary system and method 10 according to the principles of the present invention includes a natural language processing system for producing and storing SAO Knowledge Base data, such as SAO structures. Further details of examples of such a system 10 is disclosed in Reference Nos. 3, 4, and 5 above.

According to one aspect of the present invention a user searching for stored document information enters into system 10 a user request at 12. The user request can be a natural language phrase, sentence (statement or question), paragraph keyed or otherwise entered by user or a document or document portion (such as a patent specification, claim, or abstract) keyed, scanned, downloaded or otherwise entered to use request 12. For example, user speaks into a voice recognition system, “The heat exchanger cools the oil.”

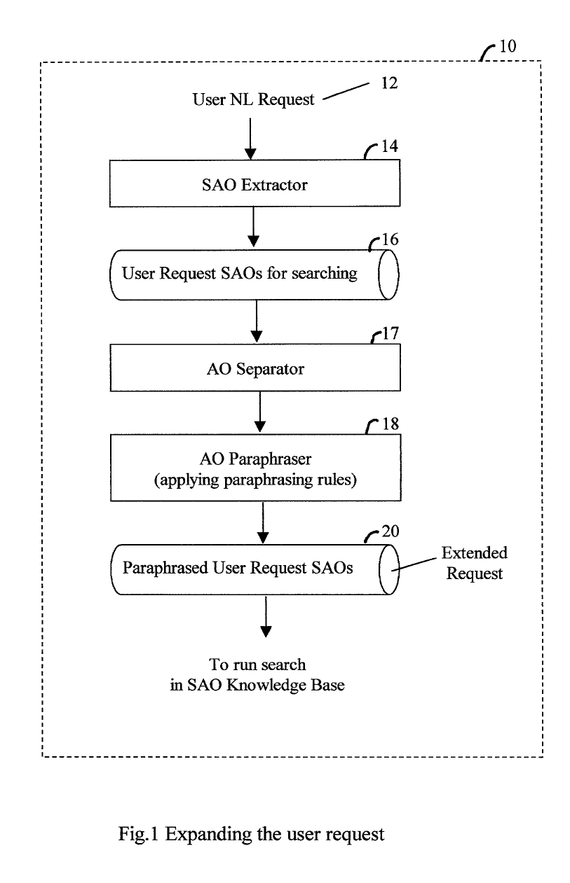

With reference to the main stages of expanding the user request, FIG. 1, Natural language user request 12 is applied to SAO extractor 14. For example, “heat exchanger” (S) “cools” (A) “oil” (0). SAO extractions are applied to and stored at 16. Step 17 identifies and separates the S of each SAO extraction from the respective AO for further processing the AOs. Step 18 applies a set of paraphrasing rules to generate para-AOs in accordance with, in one example, the following paraphrasing rules:

AO Paraphrasing Positive Rules

Rule 1.
<AO> = <A*> <A-ing/ion> <O>
Where:
<A> - any action,
<O> - any object,
<A-ing/ion> - the ing/ion form of the A,
<A*> = realize | accomplish | fulfill | perform | permit | enable |
allow | provide | achieve | . . . .
Example:
Cool oil = perform cooling oil
Cool <A> oil <O> = perform <A*> cooling <A-ing> oil <O>
Rule 2.
<AO> = <A*> <O> <A-ing/ion>
Example:
cool oil = provide oil cooling
cool <A> oil <O> = provide <A*> oil <O> cooling <A-ing>
Rule 3.
<AO> = <A-ing/ion> <O> <A*passive> <P>
Where:
<P> = by | with the help of | by means of | . . . .
Example:
cool oil = cooling oil is accomplished by
cool <A> oil <O> = cooling <A-ing> oil <O> is accomplished
<A*passive> by <P>
Rule 4.
<AO> = <A*> <A-ing/ion> of <O>
Example:
cool oil = perform cooling of oil
cool <A> oil <O> = perform <A*> cooling <A-ing> of oil <O>
Rule 5.
<AO> = <A-ing/ion> of <O> is <A*ed> <P>
Example:
cool oil = cooling of oil is performed by
cool <A> oil <O> = cooling <A-ing> of oil <O> is performed by <P>
In total, the rules produce about 200 semantically equivalent versions of
any given AO.
For example, for the function “cool oil”
Rule 1.
realize cooling oil
accomplish cooling oil
fulfill cooling oil
perform cooling oil
permit cooling oil
enable cooling oil
allow cooling oil
provide cooling oil
achieve cooling oil
.........................
Rule 2.
realize oil cooling
accomplish oil cooling
fulfill oil cooling
perform oil cooling
permit oil cooling
enable oil cooling
allow oil cooling
provide oil cooling
achieve oil cooling
.........................
Rule 3.
cooling oil is realized by
cooling oil is accomplished by
cooling oil is fulfilled by
cooling oil is performed by
cooling oil is permitted by
cooling oil is enabled by
cooling oil is allowed by
cooling oil is provided by
cooling oil is achieved by
.........................
cooling oil is realized with the help of
cooling oil is accomplished with the help of
cooling oil is fulfilled with the help of
cooling oil is performed with the help of
cooling oil is permitted with the help of
cooling oil is enabled with the help of
cooling oil is allowed with the help of
cooling oil is provided with the help of
cooling oil is achieved with the help of
.........................
Rule 4.
realize cooling of oil
accomplish cooling of oil
fulfill cooling of oil
perform cooling of oil
permit cooling of oil
enable cooling of oil
allow cooling of oil
provide cooling of oil
achieve cooling of oil
.........................
Rule 5.
cooling of oil is realized by
cooling of oil is accomplished by
cooling of oil is fulfilled by
cooling of oil is performed by
cooling of oil is permitted by
cooling of oil is enabled by
cooling of oil is allowed by
cooling of oil is provided by
cooling of oil is achieved by
.........................
cooling of oil is realized with the help of
cooling of oil is accomplished with the help of
cooling of oil is fulfilled with the help of
cooling of oil is performed with the help of
cooling of oil is permitted with the help of
cooling of oil is enabled with the help of
cooling of oil is allowed with the help of
cooling of oil is provided with the help of
cooling of oil is achieved with the help of
.........................
where “.........................” means further entries not displayed.
AO paraphrasing negative rules
The AO paraphrasing rules are correspondingly provided for negative
actions.

In natural language the negative form may be represented in two ways—directly (by means “not” particle) and indirectly, by means of verbs with negative meanings.

<n> = do not | not to | . . . ;
<An> = avoid | prevent | hamper | stop | hinder | prohibit | deter |
limit | . . . .

Correspondingly, each syntactic paraphrasing rule for negative form has two versions.

Rule 1N
(a) <n> <AO> = <n> <A*> <A-ing/ion> <O>
Example:
Do not cool oil = do not perform cooling oil
Do not <n> cool <A> oil <O> = do not <n> perform <A*> cooling
<A-ing> oil <O>
(b) <n> <AO> = <An> <A-ing/ion> <O>
Example:
Do not cool oil = prevent cooling oil
Do not <n> cool <A> oil <O> = prevent <An> cooling <A-ing>
oil <O>
Rule 2N
(a) <n> <AO> = <n> <A*> <O> <A-ing/ion>
Example:
Do not cool oil = do not perform oil cooling
Do not <n> cool <A> oil <O> = do not <n> perform <A*> oil <O>
cooling <A-ing>
(b) <n> <AO> = <An> <O> <A-ing/ion>
Example:
Do not cool oil = prevent oil cooling
Do not <n> cool <A> oil <O> = prevent <An> oil <O> cooling <A-ing>
Rule 3N
(a) <n> <AO> = <A-ing/ion> <O> <n> <A* passive> <P>
Example:
Do not cool oil = cooling oil is not performed by
Do not <n> cool <A> oil <O> = cooling <A-ing> oil <O> is not <n>
performed <A* passive> by <P>
(b) <n> <AO> = <A-ing/ion> <O> <(An) passive> <P>
Example:
Do not cool oil = cooling oil is prevented by
Do not <n> cool <A> oil <O> = cooling <A-ing> oil <O> is prevented
<(An) passive> by <P>
Rule 4N
(a) <n> <AO> = <n> <A*> <A-ing/ion> of <O>
Example:
Do not cool oil = do not perform cooling of oil
Do not <n> cool <A> oil <O> = do not <n> perform <A*> cooling
<A-ing> of oil <O>
(b) <n> <AO> = <An> <A-ing/ion> of <O>
Example:
Do not cool oil = prevent cooling of oil
Do not <n> cool <A> oil <O> = prevent <An> cooling <A-ing> of oil
<O>
Rule 5N
(a) <n> <AO> = <A-ing/ion> of <O> <n> <A* passive> <P>
Example:
Do not cool oil = cooling of oil is not performed by
Do not <n> cool <A> oil <O> = cooling <A-ing> of oil <O> is not
<n> performed <A* passive> by <P>
(b) <n> <AO> = <A-ing/ion> of <O> <(An) passive> <P>
Example:
Do not cool oil = cooling of oil is prevented by
Do not <n> cool <A> oil <O> = cooling <A-ing> of oil <O> is prevented
<(An) passive> by <P>

As seen from the above examples, the user request SAOs are expanded at stage 18 to include many para-AOs associated with a common respective S. These user request SAOs and para-SAOs are stored at 20 to provide expanded user search request for seeking information from the systems SAO Knowledge Base.

### EXAMPLE NO. 2

One more example of positive and negative paraphrasing rules in more general notation is given below.

```
Positive Paraphrasing Rules
  1. <AO> ::= <BE> <ABLE> <AT> <PROCESS>
  2. <AO> ::= <BE> <ABLE> to <A> <O>
  3. <S> <AO> ::= it <BE> <ABLE> for <S> to <A> <O>
  4. <AO> ::= <BE> not <UNABLE> <AT> <PROCESS>
  5. <AO> ::= <BE> not <UNABLE> to <A> <O>
  6. <S> <AO> ::= it <BE> not <UNABLE> for <S> to <A> <O>
  7. <S> <AO> ::= <FORCE> <S> to <A> <O>
  8. <AO> ::= <SEEM> to <A> <O>
  9. <AO> ::= <PROVIDE> <PROCESS>
10. <AO> ::= <PROVIDE> <A-ed> <O>
11. <AO> ::= <N> <FAIL> to <A> <O>
12. <AO> ::= <N> <PREVENT> <PROCESS>
13. <AO> ::= <BE> <DIRECTED_AT> <PROCESS>
14. <AO> ::= <FOCUS_ON> <PROCESS>
15. <AO> ::= <BE> <USE> to <A> <O>
16. <AO> ::= <BE> <USE> for <PROCESS>
17. <S> <AO> ::= <USE> <S> to <A> <O>
18. <S> <AO> ::= <USE> <S> for <PROCESS>
19. <AO> ::= <BE> <MEANS> to <A> <O>
20. <AO> ::= <BE> <MEANS> (of | for) <PROCESS>
21. <AO> ::= <HAVE> <MEANS> to <A> <O>
22. <AO> ::= <HAVE> <MEANS> (of | for) <PROCESS>
23. <AO> ::= <BE> <DOER>
. . .
Here the meta-linguistic variables < . . . > are:
<A> - any action;
<O> - any object;
<X> - any subject;
<BE> ::= be | am | are | is | were | was | have been | has been | had been | being
| become | stay | remain | appear | occur | happen | prove | seem | <MD> be | . . . ;
<MD> ::= can | could | will | shall | should | ought | must | may | might | . . . ;
<ABLE> ::= able | acceptable | accessible | adaptable | adjustable | admissible |
affordable | adequate advantageous | agreeable | attractive | available |
beneficial | capable | configurable | conventional | customary | typical | convenient
| critical | desirable | effective | easy | essential | excellent | good | better | best |
great | guilty | helpful | important | significant | crucial | feasible | fine | favourable |
favourite | indispensible | ideal | operable | operative | optional | possible |
preferable | primary | practical | ready | responsible | suitable | superb | simple |
usable | useful | usual | common | appropriate | apt | fit | fitting | right | proper |
correct | satisfactory | sufficient | successful | enough | applicable | opportune |
passable | necessary | needed | valid | well-suited | willing | . . . ;
<AT> ::= at | in | of | for | . . . ;
<PROCESS> ::= <A-ing> <O> | <O> <A-ing/ion> | <A-ing/ion> of <O>
<A-ing/ion> - the ing/ion form of the A,
<UNABLE> ::= unable | incapable | impossible | helpless | difficult | insufficient |
ineffective | inefficient | impractical | impracticable | unavailable | unpractical |
unacceptable | inaccessible | inadmissible | insignificant | unimportant |
unessential | inoperable | inappropriate | unfit | useless | unuseful | bad | unready
| undesirable | improper | unsuitable | unsatisfactory | unusual | untypical |
atypical | unapt | unsuccessful | . . . ;
<FORCE> :: = be | have | want | get | prefer | take | include | comprise | integrate |
allege | allow | assure | bind | cause | claim | concern | conduct | confirm | contain
| contemplate | deem | demand | denote | ensure | enable | engage | encourage |
execute | expect | explain | feature | force | find | implement | incline | induce
involve | know | lead | like | make | motivate | need | oblige | obtain | orient |
permit | practice | predict | prompt | propose | provide | repeat | report | reproduce
| repute | represent | request | require | say | secure | see | shape | show | tell |
tune | describe | suggest | suppose | suspect | teach | think | warn | wish | choose
| understand | force | advise | aid | allow | expect | anticipate | ask | order |
command | request | help | assist | assume | authorize | believe | consider |
regard | think | bother | cause | challenge | choose | claim | compel | conduct |
create | drive | enable | encourage | . . . ;
<SEEM> ::= exist | come | try | attempt | seek | suffice | choose | decide | appear |
operate | begin | continue | proceed | intend | finish | happen | seem | start | stop |
cease | tend | serve | act | function | need | allow | permit | function | cooperate |
learn | study | evolve | resume | repeat | like | love | prefer | help | care | claim |
deserve | want | desire | demand | do | enable | endeavour | endeavor |
encourage | end | present | prepare | plan | go | go on | get | threaten hesitate |
honor | honour | hope | hurry | long | look | manage | cope | opt | persist | probe |
promise | prove | propose | suggest | require | risk | show | strive | succeed | suit |
use | vow | wait | wish | . . . ;
<PROVIDE> :: = provide | involve | attain | comprise | realize | accomplish | fulfil |
perform | permit | enable | allow | achieve | execute | warrant | guarantee | ensure
| assure | cause | force | begin | start | continue | launch | stimulate | encourage |
impel | compel | spur | initiate | incite | touch off | trigger | give rise to | make | do |
promise | . . . ;
<A-ed> - ed-form of <A>;
<N> ::= have not | has not | do not | does not | had not | did not | <MD> not | . . . ;
<FAIL> ::= fail | forget | avoid | prohibit | forbid | . . . ;
<PREVENT> ::= prevent | encumber | hamper | hinder | impede | obstruct |
inhibit | stop | quit | avoid | prohibit | limit | deter | constrain | forbid | disturb |
interrupt | . . . ;
<DIRECTED_AT> ::= aimed at | directed at | characterized by | focused on |
specialized on | . . . ;
<FOCUS_ON> ::= focus on | allow for | aim at | direct at | focus on | specialize on
| succeed in | . . . ;
<USE> ::= accommodate | accomplish | achieve | acquire | activate | actuate |
adapt | add | adjust | adope | adopt | advance | advise | advocate | aim | allege |
allocate | allot | allow | anger | anticipate | appear | apply | appoint | approve |
architect | argue | arrange | ask | assemble | assume | astonish | attach | attempt |
authorize | begin | believe | bless | bear | bind | build | call | cause | challenge |
charge | choose | claim | commit | compel | compile | complete | conceive |
conduct | configure | confirm | consider | constrain | construct | construe |
consume | continue | contribute | convene | create | customize | dedicate | deem |
define | delight | demonstrate | deposit | derive | describe | designate | design |
desire | destine | develop | devise | devote | direct | disclose | dispose | do | doom
| drive | elaborate | elect | embarrass | employ | empower | enable | enact |
encourage | endeavour | engage | engineer | entitle | envisage | equip | erect |
establish | estimate | evoke | evolve | execute | exercise | exert | expect |
experiment | explain | exploit | fabricate | favor | fit | focus | follow | force | form |
find | function | gather | give | get | group | grow | guarantee | happen | harness |
help | hire | honor | honour | hope | hypothesize | illustrate | implement | impose |
incline | include | incorporate | induce | infer | initiate | install | instigate | institute |
instruct | intend | introduce | invent | invite | invoke | involve | justify | know |
launch | leave | license | locate | make | make use of | manufacture | mean |
model | motivate | mount | need | obligate | oblige | observe | obtain | order |
organise | organize | orient | outline | overdesign | perceive | perform | permit |
persuade | place | plan | please | pose | position | postulate | predict | predispose
|prefer | prepare | prescribe | present | presume | produce | programme |
program | propose | prove | provide | purchase | qualify | realise | realize |
recommend | register | report | repute | request | require | result | see | select |
sentence | set | settle | shape | show | size | seek | specialize | specify | speculate
| start | state | suggest | suite | summon | supplement | supply | support | suppose
| surprise | suspect | synthesize | tailor | tailour | take | take into account | take
into consideration | target | task | teach | think | tell | train try | tune | ultilize |
understand | undertake | update | upgrade | use | utilise | utilize | want | warn |
warrant | . . . ;
<MEANS> ::= means | way | method | procedure | process | ability | talent |
possibility | success | capacity | habit | desire | tendency | chance | opportunity |
. . . ;
<HAVE> ::= have | has | had | having | acquire | obtain | get | . . . ;
<DOER> :: = <A-er> of <O>;
<A-er> - er/or form of <A>.
For example, for the function “pump water” the above-
mentioned rules describe the paraphrases like:
```

| | |
|---|---|
| 1. | pump water = is good at pumping water |
| | pump water <AO> = is <BE> good <ABLE> at <AT> pumping water |
| | <PROCESS> |
| 2. | pump water = is suitable to pump water |
| | pump water <AO> = is <BE> suitable <ABLE> to pump <A> water <O> |
| 3. | device pump water = it is possible for device to pump water |
| | device <S> pump water <AO> = it is <BE> possible <ABLE> for device <S> |
| | to pump <A> water <O> |
| 4. | pump water = is not unable of pumping water |
| | pump water <AO> = is <BE> not unable <UNABLE> of <AT> pumping water |
| | <PROCESS> |
| 5. | pump water = is not unable to pump water |
| | pump water <AO> = is <BE> not unable <UNABLE> to pump <A> water <O> |
| 6. | device pump water :: = it is not impossible for device to pump water |
| | device <S> pump water <AO> = it is <BE> not impossible <UNABLE> for |
| | device <S> to |
| | pump <A> water <O> |
| 7. | device pump water = cause device to pump water |
| | device <S> pump water <AO> = cause <FORCE > device <S> to pump <A> |
| | water <O> |
| 8. | pump water = try to pump water |
| | pump water <AO> = try <SEEM> to pump <A> water <O> |
| 9. | pump water = perform pumping of water |
| | pump water <AO> = perform <PROVIDE> pumping of water <PROCESS> |
| 10. | pump water = guarantee pumped water |
| | pump water <AO> = guarantee <PROVIDE> pumped <A-ed> water <O> |
| 11. | pump water = doesn't fail to pump water |
| | pump water <AO> = doesn't <N> fail <FAIL> to pump <A> water <O> |
| 12. | pump water = does not stop pumping water |
| | pump water <AO> = does not <N> stop <PREVENT> pumping water |
| | <PROCESS> |
| 13. | pump water = is directed at water pumping |
| | pump water <AO> = is <BE> directed at <DIRECTED_AT> water pumping |
| | <PROCESS> |
| 14. | pump water = succeed in water pumping |
| | pump water <AO> = succeed in <FOCUS_ON> water pumping <PROCESS> |
| 15. | pump water = is known to pump water |
| | pump water <AO> = is <BE> known <USE> to pump <A> water <O> |
| 16. | pump water = has been created for pumping of water |
| | pump water <AO> = has been <BE> created <USE> for pumping of water |
| | <PROCESS> |
| 17. | device pump water = somebody uses device to pump water |
| | device <S> pump water <AO> = somebody uses <USE> device <S> to pump |
| | <A> water <O> |
| 18. | device pump water = somebody invents device for water pumping |
| | device <S> pump water <AO> = somebody invents <USE> device <S> for |
| | water pumping <PROCESS> |
| 19. | pump water = is method to pump water |
| | pump water <AO> = is <BE> method <MEANS> to pump <A> water <O> |
| 20. | pump water = is means for pumping water |
| | pump water <AO> = is <BE> means <MEANS> for pumping water |
| | <PROCESS> |
| 21. | pump water = has ability to pump water |
| | pump water <AO\| C> has <HAVE> ability <MEANS> to pump <A> water <O> |
| 22. | pump water = has ability for pumping water |
| | pump water <AO> = has <HAVE> ability <MEANS> for pumping water |
| | <PROCESS> |
| 23. | indicate signal = is indicator of signal |
| | indicate signal <AO> = is <BE> indicator of signal <DOER> |

Negative Paraphrasing Rules

| | |
|---|---|
| 1n. | <N> <AO> ::= <BE> not <ABLE> <AT> <PROCESS> |
| 2n. | <N> <AO> ::= <BE> not <ABLE> to <A> <O> |
| 3n. | <S> <N> <AO> ::= it <BE> not <ABLE> for <S> to <A> <O> |
| 4n. | <N> <AO> ::= <BE> <UNABLE> <AT> <PROCESS> |
| 5n. | <N> <AO> ::= <BE> <UNABLE> to <A> <O> |
| 6n. | <S> <N> <AO> ::= it <BE> <UNABLE> for <S> to <A> <O> |
| 7n. | <S> <N> <AO> ::= <FORCE> <S> not to <A> <O> |
| | <S> <N> <AO> ::= <N> <FORCE> <S> to <A> <O> |
| 8n. | <N> <AO> ::= <SEEM> not to <A> <O> |
| | <N> <AO> ::= <N> <SEEM> to <A> <O> |
| 9n. | <N> <AO> ::= <N> <PROVIDE> <PROCESS> |
| | <N> <AO> ::= <PROVIDE> no <PROCESS> |
| 10n. | <N> <AO> ::= <N> <PROVIDE> <A-ed> <O> |
| | <N> <AO> ::= <PROVIDE> no <A-ed> <O> |
| 11n. | <N> <AO> ::= <FAIL> to <A> <O> |
| 12n. | <N> <AO> ::= <PREVENT> <PROCESS> |
| 13n. | <N> <AO> ::= <BE> not <DIRECTED_AT> <PROCESS> |
| 14n. | <N> <AO> ::= <N> <FOCUS_ON> <PROCESS> |
| 15n. | <N> <AO> ::= <BE> not <USE> to <A> <O> |
| 16n. | <N> <AO> ::= <BE> not <USE> for <PROCESS> |
| 17n. | <S> <N> <AO> ::= <N> <USE> <S> to <A> <O> |
| 18n. | <S> <N> <AO> = <N> <USE> <S> for <PROCESS> |
| 19n. | <N> <AO> ::= <BE> not <MEANS> to <A> <O> |
| 20n. | <N> <AO> ::= <BE> not <MEANS> (of \| for) <PROCESS> |
| 21n. | <N> <AO> ::= <N> <HAVE> <MEANS> to <A> <O> |
| | <N> <AO> ::= <HAVE> no <MEANS> to <A> <O> |
| 22n. | <N> <AO> ::= <N> <HAVE> <MEANS> (of \| for) <PROCESS> |
| | <N> <AO> ::= <HAVE> no <MEANS> (of \| for) <PROCESS> |
| 23n. | <N> <AO> ::= <BE> not <DOER> |

Where:
<N> :: = do not | not to | . . . .

For example, for the function “pump water” the above-mentioned rules describe the paraphrases like:

| | |
|---|---|
| 1n. | not pump water = is not good at pumping water |
| | not <N> pump water <AO> = is <BE> not good <ABLE> at <AT> pumping |
| | water <PROCESS> |
| 2n. | not pump water = is not suitable to pump water |
| | not <N> pump water <AO> = is <BE> not suitable <ABLE> to pump <A> |
| | water <O> |
| 3n. | device not pump water = it is not possible for device to pump water |
| | device <S> not <N> pump water <AO> = it is <BE> not possible <ABLE> for |
| | device <S> to pump <A> water <O> |
| 4n. | not pump water = is unable of pumping water |
| | not <N> pump water <AO> = is <BE> unable <UNABLE> of <AT> pumping |
| | water <PROCESS> |
| 5n. | not pump water = is unable to pump water |
| | not <N> pump water <AO> = is <BE> unable <UNABLE> to pump <A> water |
| | <O> |
| 6n. | device not pump water = it is impossible for device to pump water |
| | device <S> not <N> pump water <AO> = it is <BE> impossible <UNABLE> |
| | for device <S> to pump <A> water <O> |
| 7n. | device not pump water = cause device not to pump water |
| | device <S> not <N> pump water <AO> = cause <FORCE > device <S> not to |
| | pump <A> water <O> |
| | device not pump water = doesn't cause device to pump water |
| | device <S> not <N> pump water <AO> = doesn't <N> cause <FORCE> |
| | device <S> to pump <A> water <O> |
| 8n. | not pump water = try not to pump water |
| | not <N> pump water <AO> = try <SEEM> not to pump <A> water <O> |
| | not pump water = doesn't try to pump water |
| | not <N> pump water <AO> = doesn't <N> try <SEEM> to pump <A> water |
| | <O> |
| 9n. | not pump water = doesn't perform pumping of water |
| | not <N> pump water <AO> = doesn't <N> perform <PROVIDE> pumping of |
| | water <PROCESS> |
| | not pump water = performs no pumping of water |
| | not <N> pump water <AO> = performs <PROVIDE> no pumping of water |
| | <PROCESS> |
| 10n. | not pump water = doesn't guarantee pumped water |
| | not <N> pump water <AO> = doesn't <N> guarantee <PROVIDE> pumped |
| | <A-ed> water <O> |
| | not pump water = guarantee no pumped water |
| | not <N> pump water <AO> = guarantee <PROVIDE> no pumped <A-ed> |
| | water <O> |
| 11n. | not pump water = failed to pump water |
| | not <N> pump water <AO> = failed <FAIL> to pump <A> water <O> |
| 12n. | not pump water = stop pumping water |
| | not <N> pump water <AO> = stop <PREVENT> pumping water <PROCESS> |
| 13n. | not pump water = is not directed at water pumping |
| | not <N> pump water <AO> = is <BE> not directed at <DIRECTED_AT> water |
| | pumping <PROCESS> |
| 14n. | not pump water = did not succeed in water pumping |
| | not <N> pump water <AO> = did not <N> succeed in <FOCUS_ON> water |
| | pumping <PROCESS> |
| 15n. | not pump water = is not known to pump water |
| | not <N> pump water <AO> = is <BE> not known <USE> to pump <A> water |
| | <O> |
| 16n. | not pump water = was not created for pumping of water |
| | not <N> pump water <AO> = was <BE> not created <USE> for pumping of |
| | water <PROCESS> |
| 17n. | device not pump water = somebody does not use device to pump water |
| | device <S> not <N> pump water <AO> = somebody does not <N> use |
| | <USE> device <S> to pump <A> water <O> |
| 18n. | device not pump water = somebody did not invent device for water pumping |
| | device <S> not <N> pump water <AO> = somebody did not <N> invent <USE> |
| | device <S> for water pumping <PROCESS> |
| 19n. | not pump water = is not method to pump water |
| | not <N> pump water <AO> = is <BE> not method <MEANS> to pump <A> |
| | water <O> |
| 20n. | not pump water = is means for pumping water |
| | not <N> pump water <AO> = is <BE> not means <MEANS> for pumping |
| | water <PROCESS> |
| 21n. | not pump water = does not have ability to pump water |
| | not <N> pump water <AO> = does not <N> have <HAVE> ability <MEANS> |
| | to pump <A> water <O> |
| | not pump water = has no ability to pump water |
| | not <N> pump water <AO> = has <HAVE> no ability <MEANS> to pump <A> |
| | water <O> |
| 22n. | not pump water = does not have ability for pumping water |
| | not <N> pump water <AO> = does not <N> have <HAVE> ability <MEANS> |
| | for pumping water <PROCESS> |
| | not pump water = has no ability for pumping water |
| | not <N> pump water <AO> = has <HAVE> no ability <MEANS> for pumping |
| | water <PROCESS> |
| 23n. | not indicate signal = is not indicator of signal |
| | not <N> indicate signal <AO> = is <BE> not indicator of signal <DOER> |

It is necessary to note, that the plurality of rules
presented above does not include passive form of the rules
such as:

(a) <S> <AO> ::= <O> <A passive> (by | by means of | with help of)

<S>

(b) <S> <AO> ::= <PROCESS> <PROVIDE passive> (by | by means

of | with help of) <S>

since they are obvious. For example, in the case (b)

the right part will be transformed into:

<S> <PROVIDE> <PROCESS>

and after rule 9 is applied, the formula will look like:

<S> <PROVIDE> <PROCESS> = <S> <AO>

Note also, that the rules may include or do not include
subject S. If it presents, the subject will be the same for
the both parts of the rule. We have a so-called “active (or
direct) subject” here, i.e. the subject which directly
performs the function AO. If subject S is not present, the
equalities are not absolute, it is “passive (or indirect)”
subject, otherwise - it is a co-actor, being one of the
subjects (instruments) to perform AO function. Such a
paraphrase, being not semantically absolute, is, however,
close to that meaning and thus very important for SAO
information processing.

### EXAMPLE NO. 3

### User Enters a Word String with at Least One AO):

It should be understood that the above-mentioned Example No. 1 or 2 method also applies to the case in which user enters only a phrase or phrases that include no subjects (Ss). For example, if user enters “cool oil” the user request includes an AO but no S. Nevertheless, the user request is expanded in the same manner described above even though the S is absent because the rules processing applies to the AO segment regardless of the absence of an S. The system search, then, would be for all documents that have any of the para-AOs resulting from the above-mentioned processing of the user entered action—object (AO) request.

### EXAMPLE NO. 4

### Forming a Compressed SAO Knowledge Base

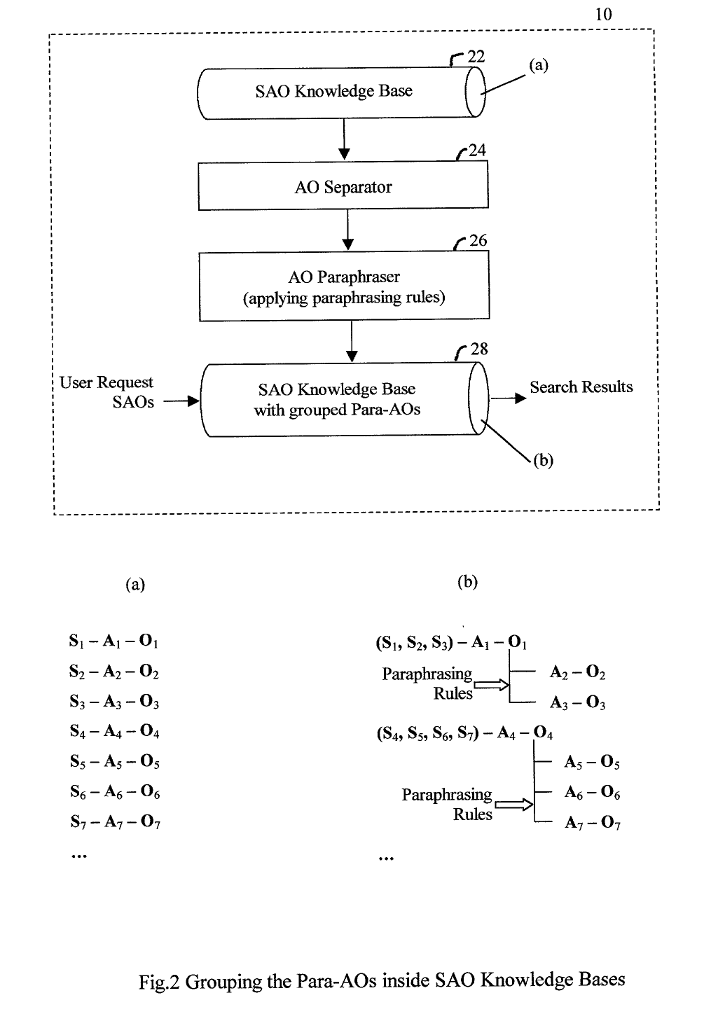

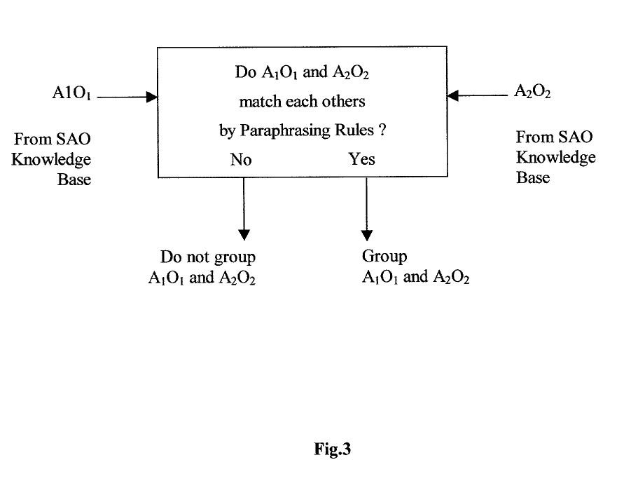

Separately or in combination with the method of Figure 1, FIG. 2 shows one exemplary embodiment of generating a compressed SAO Knowledge Base to support efficient access to and management of SAO based information. Specifically, SAO Knowledge Base is developed from processing natural language documents in accordance, for example, as disclosed in Reference Nos. 1, 2, 3, 4, or 5 above. In essence, source document data are obtained or downloaded by any known manner from local or remote databases and stored. System 10 processes source document data to extract all SAO and normalize them into SAO structures. These SAO structures are stored at 22 to form the SAO Knowledge Base. SAO structures are separated into S and AO components. Each AO component is compared in 26 to all other AOs in the document in accordance with the, for example, paraphrasing rules mentioned above for stage 18 and/or Example 1, 2, or 3 mentioned above. This stage identifies the AOs with equivalent meanings and groups them under or in association with a normalized AO with the same meaning. See FIG. 3. The grouped AOs are then stored in the grouped SAO Knowledge Base 28.

Stage 28, in response to processed user request SAOs or AOs, generates and displays the grouped SAOs for which the normalized, respective SAO or AOs matched or associated with the user request SAOs or AOs. See FIG. 2 at (b). As seen in FIG. 2, the system can group not only the AOs but also the respective Ss for display to user. This display conveys an extensive number of concepts to the user since user sees what Ss (e.g., technologies can produce what functions or problem solutions). For example, S7 may not have ever been mentioned in a document with A₅-O₅ but this displayed immediately presents this new concept (e.g., S₇-A₅-O₅) to the user.

It will be understood that the term “stored” as used herein means permanently or temporarily stored in the computer system as desired. It will also be understood that the user request can include a word string with at least one SAO or at least one AO.

1. In a digital computing system, the method comprising
storing a natural language user request that includes at least one action (A) and one object (O) of action,
extracting the AO to form an AO extraction,
processing the AO extraction pursuant to paraphrasing rules to form a plurality of para-AOs, and
using the plurality of para-AOs as an expanded user request to search for information.

2. A method according to claim 1, wherein the paraphrasing rules include paraphrasing positive rules.

3. A method according to claim 1, wherein the paraphrasing rules include paraphrasing negative rules.

4. A method according to claim 1, wherein the paraphrasing rules include paraphrasing positive and negative rules.

5. A method according to claim 1, wherein the natural language user request mentioned in said storing step includes a subject (S) in association with the AO such that the subject (S) initiates the action (A) on the object (O),
said extracting step includes extracting the SAO extraction from the stored user request.

6. A method according to claim 5, further comprising combining the S with each para-AO to form a plurality of para-SAOs as an expanded user request to search for information.

7. A method according to claim 1, further comprising comparing each of the para-AOs with knowledge base stored AOs of natural language documents and displaying to the user portions of those natural language documents in which the document portion AO matches the respective para-AO of the expanded user request.

8. A method according to claim 6, further comprising comparing each of the para-SAOs with knowledge base stored SAOs of natural language documents and displaying to the user portions of those natural language documents in which the document portion SAO matches the respective para-SAO of the expanded user request.

9. A method according to claim 1, further comprising processing natural language documents, extracting therefrom a plurality of subject, action, object triplets (SAOs), normalizing the SAOs into SAO structures and storing the SAO structures in an SAO knowledge base, and
grouping a plurality of the knowledge base SAOs that include various subjects (S₁, S₂, . . . Sₙ) each of which is associated with an AO (A₁O₁, A₁O₂, . . . AₙOₙ) wherein A₁O₁, A₂O₂, . . . AₙOₙ have a common meaning and
searching the SAO knowledge base for the group of AOs with common meaning to the user request para-AOs, and
displaying to the user those Ss (S₁, S₂, . . . Sn) or SAOs (S₁A₁O₁, S₂A₂O₂, . . . SₙAₙOₙ) that include AOs (A₁O₁, A₂O₂, . . . AₙOₙ) having a common meaning with the user request para-AOs.

10. In a digital computing system, the method of processing natural language documents, extracting a plurality of subject, action, object triplets (SAOs), normalizing the SAOs into SAO structures and storing the SAO structures in an SAO knowledge base the method characterized in that:
grouping a plurality of the SAOs that include various subjects (S₁, S₂, . . . Sₙ) each of which is associated with an AO (A₁O₁, A₁O₂, . . . AₙOₙ) wherein A₁O₁, A₂O₂, . . . AₙOₙ have a common meaning.

11. A method according to claim 10, further comprising entering a user request that includes at least one user request AO segment or at least one user request SAO, and
searching the SAO knowledge base for the group of AOs with common meaning to the user request AO, and
displaying to the user those Ss (S₁, S₂, . . . Sₙ) or SAOs (S₁A₁O₁, S₂A₂O₂, . . . SₙAₙOₙ) that include AOs (A₁O₁, A₂O₂, . . . AₙOₙ) having a common meaning with the user request AO.

12. A method according to claim 10, wherein said grouping comprises processing each knowledge base AO (A₁O₁, A₂O₂, . . . AₙOₙ) according to paraphrasing rules and identifying those AOs (A₁O₁, A₂O₂, . . . A₃O₃) that have a common meaning.

13. A method according to claim 12, wherein the paraphrasing rules includes positive rules.

14. A method according to claim 12, wherein the paraphrasing rules includes negative rules.

15. A method according to claim 12, wherein the paraphrasing rules includes positive and negative rules.

16. A method according to claim 11, further comprising processing the user request AO pursuant to paraphrasing rules to form a plurality of user request para-AOs with the user knowledge base grouped AOs to identify those grouped AOs that have a common meaning with the user request para-AOs.

17. A method according to claim 16, further comprising displaying those knowledge base grouped AOs that have a common meaning with the user request para-AOs.

18. In a digital computing system, the method comprising
storing data representing a natural language sentence segment that includes at least one action (A) and one object (O) of the action,
extracting the AO to form an AO extraction,
processing the AO extraction pursuant to paraphrasing rules to form a plurality of para-AOs, and
using the plurality of para-AOs during subsequent processing steps to be implemented in the digital computing system.

19. A method according to claim 18, wherein the sentence segment further includes a Subject (S) causing the action (A), said extracting includes extracting the SAO to form an SAO extraction, said processing includes processing the SAO to form para-SAO's, and said using includes using the para-SAO's during subsequent processing. includes using the para-SAO's during subsequent processing.
